(19) United States
(12) Patent Application Publication
(10) Pub. No.: US 2018/0253047 A1
(43) Pub. Date: Sep. 6, 2018

(54) FIXING DEVICE AND IMAGE FORMING APPARATUS

(71) Applicant: CANON KABUSHIKI KAISHA, Tokyo (JP)

(72) Inventors: Naoki Hashimoto, Kashiwa-shi (JP); Shutaro Saito, Tokyo (JP)

(21) Appl. No.: 15/906,512

(22) Filed: Feb. 27, 2018

(30) Foreign Application Priority Data
Mar. 1, 2017 (JP) 2017-038182
Dec. 28, 2017 (JP) 2017-252970

(51) Int. Cl. G03G 15/20

(52) U.S. Cl. CPC G03G 15/2085; G03G 15/2017; G03G 2221/1639; G03G 21/1685; G03G 21/1633

(57) ABSTRACT

A fixing device includes a first unit including a first rotatable member; a second unit including a second rotatable member forming a nip, in cooperation with the first rotatable member, for fixing a toner image on a recording material; a frame supporting the second unit; a guiding member movable between a guiding position for guiding the recording material toward the nip and a retracted position where the guiding member is retracted from a space permitting demounting of the second unit from the frame; a cover member openable for exposing the space; and an interrelating mechanism configured to restore the guiding member, which is in the retracted position when the cover member is in an open position, to the guiding position in interrelation with movement of the cover member from the open position to a closed position.

### FIELD OF THE INVENTION AND RELATED ART

The present invention relates to a fixing device and an image forming apparatus and is applied to a copying machine, a printer, a facsimile machine, and the like which employ an electrophotographic type, for example.

As regards a roller or a between used in the fixing device, a durable lifetime is determined, and therefore, is periodically exchanged by a service person. In such a fixing device, in addition to improvement of productivity and an image quality, improvement of an exchange operativity of a component part by the service person is desired.

In the fixing device, as a guiding member for guiding a recording material to a nip, a fixing (device) entrance guide is provided upstream of the nip with respect to a recording material feeding direction in some cases. As regards this fixing entrance guide, in order to stably guide the recording material into the nip, a free end of the fixing entrance guide on the nip side may preferably be close to the nip.

However, when the free end of the fixing entrance guide is close to the nip, a locus drawn when a pressing roller or a pressing unit is exchanged with a new article crosses the fixing entrance guide, so that the exchange of the pressing roller is obstructed.

Therefore, in order to avoid interference between the fixing entrance guide and the pressing unit, in Japanese Laid-Open Patent Application 2011-22536, when the pressing unit is demounted from a frame, the fixing entrance guide is retracted so as not to overlap with the pressing unit in a projection region of a rotatable pressing member. Then, when the pressing unit is returned to an original position, in order to prevent forgetfulness to close the fixing entrance guide (forgetfulness to set the position of the fixing entrance guide from a retracted position to an original installation position), a mechanism for detecting the position of the fixing entrance guide by a photosensor is provided.

However, in the above-described prior art, there is a problem such that the number of component parts increases and a cost becomes high and that adjustment also becomes complicated.

### SUMMARY OF THE INVENTION

A principal object of the present invention is to provide a fixing device and an image forming apparatus which are capable of inexpensively and easily achieving prevention of forgetfulness to return a position of a guiding member from a retracted position to a guiding position.

According to an aspect of the present invention, there is provided a fixing device comprising: a first unit including a first rotatable member; a second unit including a second rotatable member forming a nip, in cooperation with the first rotatable member, for fixing a toner image on a recording material; a frame supporting the second unit; a guiding member movable between a guiding position for guiding the recording material toward the nip and a retracted position where the guiding member is retracted from a space permitting demounting of the second unit from the frame; a cover member openable for exposing the space; and an interrelating mechanism configured to restore the guiding member, which is in the retracted position when the cover member is in an open position, to the guiding position in interrelation with movement of the cover member from the open position to a closed position.

According to another aspect of the present invention, there is provided an image forming apparatus comprising: an image forming portion configured to form a toner image; a first unit including a first rotatable member; a second unit including a second rotatable member forming a nip, in cooperation with the first rotatable member, for feeding a recording material; a frame supporting the second unit; a guiding member movable between a guiding position for guiding the recording material toward the nip and a retracted position where the guiding member is retracted from a space permitting demounting of the second unit from the frame; a cover member openable for exposing the space; and an interrelating mechanism configured to restore the guiding member, which is in the retracted position when the cover member is in an open position, to the guiding position in interrelation with movement of the cover member from the open position to a closed position.

Further features of the present invention will become apparent from the following description of exemplary embodiments with reference to the attached drawings.

### BRIEF DESCRIPTION OF THE DRAWINGS

FIG. 1 is a sectional view for illustrating a schematic structure of an image forming apparatus in which a fixing device according to an embodiment is mounted.

FIG. 2 is a sectional view for illustrating a schematic structure of the fixing device in the embodiment.

FIG. 3 is a sectional view showing a state when a pressing roller of the fixing device in the embodiment is demounted.

FIG. 4 is a sectional view showing an operation in which the pressing roller of the fixing device in the between is exchanged and an openable cover is closed.

### DESCRIPTION OF THE EMBODIMENTS

Embodiments of the present invention will be specifically described with reference to the drawings.

### First Embodiment

### (Image Forming Apparatus)

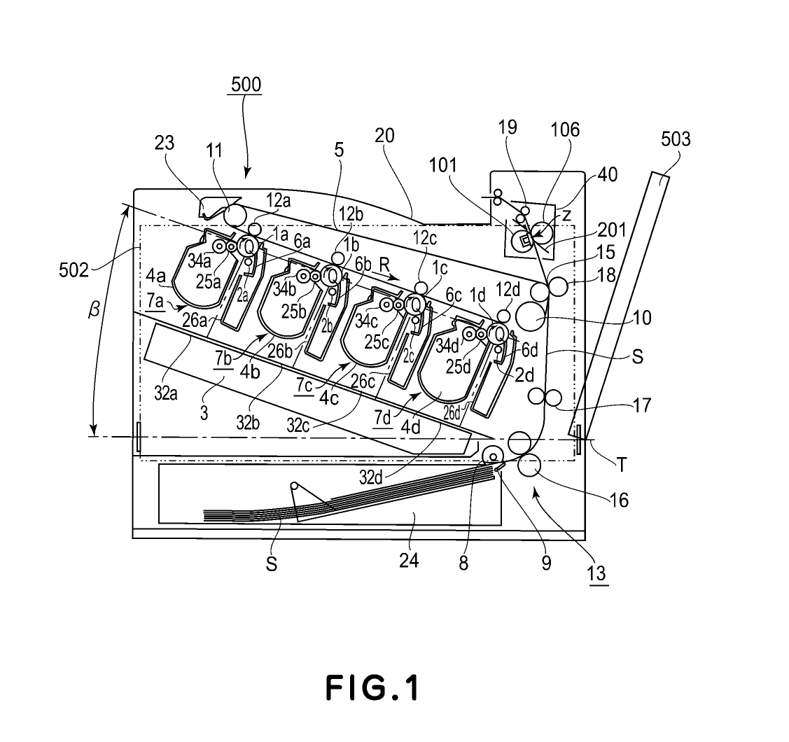

An image forming apparatus 500 in this embodiment includes an image forming portion for forming a toner image on a recording material and a fixing portion (fixing device) for fixing the toner image, and a sectional view thereof is shown in FIG. 1. Four cartridges 7 (7a-7d) which are juxtaposed obliquely downwardly in the named order include photosensitive drum units 26 (26a-26d) including photosensitive drums 1 (1a-1d) as electrophotographic photosensitive members and developing units 4 (4a-4d). Each of the cartridge 7a-7d is provided detachably mountable to a main assembly of the image forming apparatus.

The photosensitive drums 1 are rotationally driven clockwisely (in Q direction) in FIG. 1 by a driving member (not shown). At peripheries of the photosensitive drums 1, in the order of a rotational direction thereof, cleaning members 6 (6a-6d), charging rollers 2 (2a-2d) and the developing units 4 are provided.

The cleaning members 6 remove toner agents remaining on the photosensitive drums 1 after the toner images are transferred from the photosensitive drums 1 onto an intermediary transfer belt 5. The toner agents removed by the cleaning members 6 are collected in toner chambers in the photosensitive member units 26 (26a-26d).

The charging rollers 2 electrically charge surfaces of the photosensitive drums 1 uniformly. After the surfaces of the photosensitive drums 1 are charged by the charging rollers 2, the surfaces of the photosensitive drums 1 are exposed to laser light from a scanner unit (exposure means) 3 through unit openings 32 (32a-32d). As a result, electrostatic latent images are formed on the surfaces of the photosensitive drums 1. In this embodiment, the scanner unit 3 is disposed below the cartridges 7.

The developing units 4 supply the toner agents to the electrostatic latent images formed on the photosensitive drums 1 and develop the electrostatic latent images into the toner images. The developing units 4 include developing rollers 25 (25a-25d) for supplying the toner agents to the surfaces of the photosensitive drums 1 in contact with the photosensitive drums 1 and supplying rollers 34 (34a-34d) for supplying the toner agents to the surfaces of the developing rollers 25 in contact with the developing rollers 25.

When the image is formed on a recording material S, first, the electrostatic latent images formed on the surfaces of the photosensitive photosensitive drums 1 by the scanner unit 3 are developed into the toner images by the cartridges 7 and then are transferred onto the intermediary transfer belt 5. The intermediary transfer belt 5 is stretched by a driving roller 10 and a tension roller 11 and is driven in an arrow R direction in FIG. 1. Inside the intermediary transfer belt 5, primary transfer rollers 12 (12a-12d) are provided opposed to the drums 1, and to the primary transfer rollers 12, transfer biases are applied by unshown bias applying means.

As regards the transfer biases, for example, in the case where negatively charged toner agents are used, by applying positive biases to the primary transfer rollers 12, the toner images are successively transferred onto the intermediary transfer belt 5. Then, the four color toner images are fed to a secondary transfer portion 15 in a state in which four color toner images are superposed on the intermediary transfer belt 5. At this time, the toner agents remaining on the intermediary transfer belt 5 after the secondary transfer onto the recording material S are removed by a transfer belt cleaning device 23, and the removed toner agents pass through a residual (waste) toner feeding path (not shown) and are collected by a residual (waste) toner collecting container (not shown).

On the other hand, in sychronism with an image forming operation described above, the recording material S is fed toward the secondary transfer portion 15 by a feeding mechanism including a feeding device 13, a registration roller pair 17 and the like. The feeding device 13 includes a feeding cassette 24 for accommodating a plurality of recording materials S, a feeding roller 8 and a feeding roller pair 16 for feeding the fed recording material S. The feeding cassette 24 is detachably mountable to the image forming apparatus 500, and a user pulls out the feeding cassette 24 and demounts the feeding cassette 24 from the image forming apparatus 500, and then sets the recording materials S in the feeding cassette 24 and inserts the feeding cassette 24 into the image forming apparatus 500, so that supply of the recording materials S can be completed.

Of the recording materials S accommodated in the feeding cassette 24, the recording material S located in an uppermost portion is separated one by one by press-contact of the feeding roller 8 and a separation pad 9 with rotation of the feeding roller 8 (friction separation type), and then is fed. The recording material S fed from the feeding device 13 is fed to the secondary transfer portion 15 by the registration roller pair 17. At the secondary transfer portion 15, by applying a positive bias to a secondary transfer roller 18, it is possible to secondary-transfer the four color toner images from the intermediary transfer belt 5 onto the fed recording material S.

Then, the recording material S is fed from the secondary transfer portion 15 to a fixing device 40, in which heat and pressure are applied to the images transferred on the recording material S, so that the images are fixed on the recording material S. Thereafter, the recording material S on which the toner images are fixed is discharged onto a discharge tray 20 by a discharging roller pair 19.

### (Fixing Device)

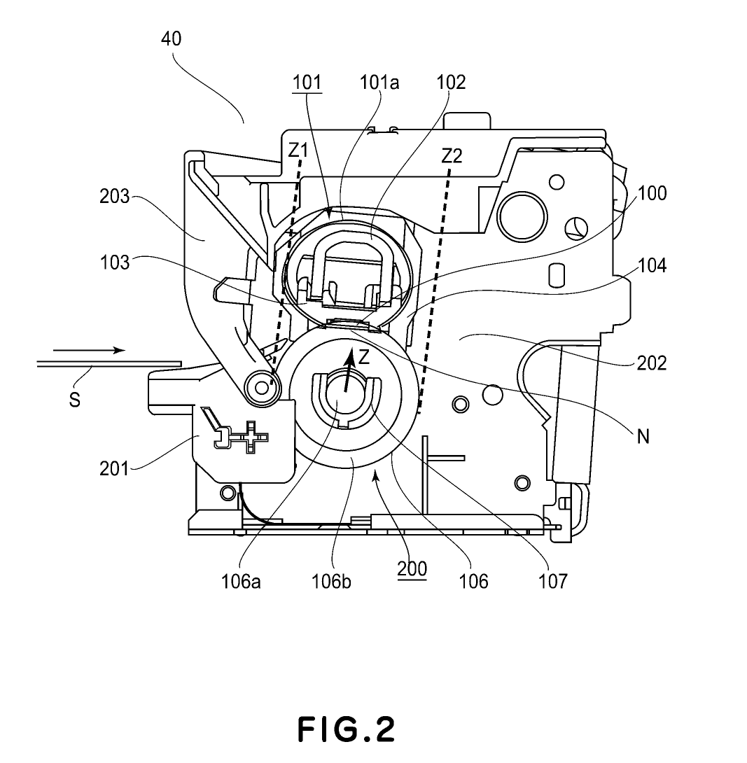

Next, the fixing device 40 will be described specifically using FIG. 2. Incidentally, a longitudinal direction described below refers to a direction perpendicular to the recording material feeding direction in a plane parallel to a recording material feeding surface. The fixing device 40 is of a film heating type and includes a first fixing unit (heating unit, first unit) 101 including a cylindrical fixing film 101a as a fixing member. Further, the fixing device 40 includes a second fixing unit (pressing unit, second unit) 200 including a pressing roller 106 which is a pressing member for forming a nip N for nipping and feeding the recording material in a state in which the pressing roller 106 opposes the fixing film 101a and is heated together with the heating unit.

In this embodiment, the heating unit includes a ceramic heater as a heating member, and the heater 100 functions as a back-up member and forms a nip N between the fixing film 101a and the pressing roller 106.

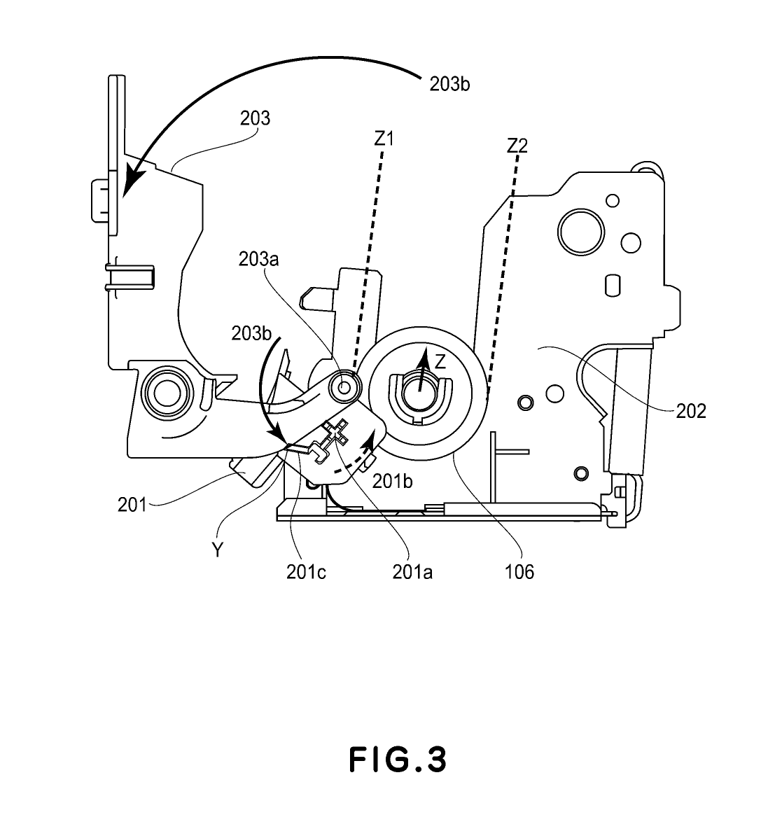

The fixing device 40 further includes a supporting member 103 for regulating an orbit of the fixing film 101a, a fixing flange 104 for regulating an end portion of the fixing film 101a, and a pressing stay 102 provided inside the fixing film 101a in order to ensure strength of the supporting member 103. Further, the fixing device 40 includes an entrance guide 201 as a guiding member for guiding the discharged and fed recording material S to the nip N and includes an openable cover 203 as an openable cover member. The openable cover 203 is assembled to a side plate 202 as shown in FIGS. 2 and 3.

The openable cover 203 is provided for the purpose of heat-insulating the fixing film 101a at a closed position and of ensuring strength of the fixing device 40. Further, as described later, a space permitting demounting of the second fixing unit 200 from the side plate 202 as a frame at an open position can be exposed. This openable cover 203 is provided relative to the fixing device 40 and is provided separately from a door (second cover member) 502 opened and closed when the cartridge 7 is mounted in and demounted from the image forming apparatus main assembly and separately from a door (second cover member) 503 opened and closed when the fixing device 40 is mounted in and demounted from the image forming apparatus main assembly. The doors 502 and 503 are provided on the image forming apparatus main assembly. Constituent members of the fixing device 40 will be described.

### 1) Heating Member

The heater 100 as a heating member has a basic structure including an elongated thin plate-like ceramic substrate and an energization heat generation resistor layer formed on a surface of the substrate, and is low thermal capacity heater which increases in temperature with an abrupt temperature rise characteristic as a whole by energization to the heat generation resistor layer. This heater 100 is engaged in and supported by an engaging groove provided on a lower surface of the press-contact member 103 along the longitudinal direction of the fixing film supporting member 103.

### 2) First Rotatable Member

The fixing film 101a as an endless belt which is a first rotatable member is a cylindrical heat-resistant member for conducting heat to the recording material S and is externally fitted around the fixing film supporting member 103. The fixing film 101a is a film having a four-layer composite structure consisting of a parting layer, an elastic layer, a base layer and an inner surface coating layer. As a material of the parting layer, a fluorine-containing resin material of 100 μm or less, preferably 20-70 μm in thickness can be used. As the fluorine-containing resin material, PTFE, PFA and the like can be cited, for example. Further, as a material of the elastic layer, for reducing thermal capacity, a rubber material of 1000 μm or less, preferably 500 μm or less in thickness can be used, and for example, a silicone rubber, a fluorine-containing rubber and the like can be cited.

Further, as a material of the base layer, a heat-resistant material of 100 μm or less, preferably 50 μm or less and 20 μm or more in thickness can be used, and for example, a metallic film of SUS, nickel or the like and a resin material such as polyimide can be used. Further, the inner surface coating layer is a resin layer having a heat-resistant property, and as a material thereof, polyimide, polyimideamide, PEEK, PTFE, FEP, PFA and the like can be cited, for example.

### 3) Second Rotatable Member

As the second rotatable member opposing the fixing film 101a, the pressing roller 106 which is the pressing member is rotationally driven by a driving means via an unshown gear attached to a longitudinal end portion thereof, so that the fixing film 101a is rotated by the pressing roller 106.

This pressing roller 106 includes a core metal 106a and a heat-resistant elastic material layer 106b which is molded and coated in a roller shape around the core metal 106a so as to be concentrically integral with the core metal 106a and which is formed with a silicone rubber, a fluorine-containing rubber, a fluorine-containing resin or the like. As a surface layer, a parting layer is provided, and as a material of the parting layer, a material, having good parting and heat-resistant properties, such as fluorine-containing resin, silicone resin, fluorosilicone rubber, fluorine-containing rubber, silicone rubber, PFA, PTFE, FEP and the like can be selected.

At both end portions of the core metal 106a with respect to the longitudinal direction, bearing members 107 formed of a heat-resistant resin material such as PEEK, PPS or liquid crystal polymer are mounted, and are disposed by being held by the side plates 202. Further, the pressing unit including the pressing roller 106 is supported by the side plates 202 so as to be demountable (described specifically later).

### 4) Fixing Film Supporting Member

The fixing film supporting member 103 not only supporting the fixing film 101a but also functioning as a press-contact member for holding the heater 100 and for causing the heater 100 to press-contact the nip.

As a material of the fixing film supporting member 103, a material having good insulating and heat-resistant properties, such as phenolic resin, polyimide resin, polyamide resin, polyamideimide resin, PEEK resin, PES resin, PPS resin, PFA resin, PTFE resin, LCP resin or the like is used.

The fixing film supporting member 103 is provided with an engaging groove so that the fixing film supporting member 103 can support the heater 100 and causes the fixing film 101a to press-contact the pressing roller 106, so that the nip N is formed.

### 5) Pressing Stay

The pressing stay 102 imparts longitudinal strength to the fixing film supporting member 103 and rectifies the fixing film supporting member 103 by being pressed against a back surface of the fixing film supporting member 103 made of a relatively soft resin.

### 6) Fixing Flange

The fixing flanges 104 are engaged with both longitudinal ends of the pressing stay 102, and not only guides rotation of the fixing film 101a but also prevents slip-out of the fixing film 101a in the longitudinal direction. The fixing flanges 104 are engaged and held by the side plates 202 as frames.

### (Exchange Pressing Unit)

Next, an exchange procedure of the pressing unit (second unit) 200 including the pressing roller 106 in this embodiment will be described using FIGS. 2, 3 and 4. In FIGS. 1 and 2, in a state in which the fixing film 101a is removed in advance, the pressing roller 106 is pulled out (demounted) along the side plate 202 in an arrow Z direction (as a demounting direction of the pressing unit, in a direction approaching a position where the heating unit is provided).

At that time, loci drawn when the pressing roller is exchanged are represented by a broken line Z1 and a broken line Z2. In order to stably guide the recording material S into the fixing nip, a free end of the entrance guide 201 on the nip side is close to the nip, and therefore, the locus Z1 interferes with the entrance guide 201.

Therefore, in this embodiment, the entrance guide 201 has a constitution in which the entrance guide 201 is movable between a guiding position where the entrance guide 201 guides the recording material and a retracted position to which the pressing unit 200 is retracted from a space permitting demounting of the pressing unit 200. When the pressing unit 200 is demounted from the side plates 202, by moving the entrance guide 201 to the retracted position, the pressing unit 200 can be demounted without interfering with the entrance guide 201. Further, in this embodiment, in order to prevent forgetfulness to return the entrance guide 201 to the guiding position when the pressing unit 200 is returned to the side plates 202, the following interrelating mechanism interrelated with a closing operation of the openable cover 203 is provided. That is, in the case where the entrance guide 201 is in the retracted position in a state in which the openable cover 203 is in the open position, the entrance guide 201 is restored to the guiding position in interrelation with movement of the openable cover 203 from the open position to the closed position. Incidentally, a method of moving the entrance guide 201 to the retracted position in order to demount the pressing unit 200 may be a method in which the movement of the entrance guide 201 is interrelated with the opening operation of the openable cover 203 by the interrelating mechanism as in this embodiment and may also be another method. For example, a constitution in which the entrance guide 201 is moved to the retracted position by a hand of an operator or a constitution in which the entrance guide 201 is automatically moved to the retracted position by drive of a motor or the like may also be employed.

As a preferred constitution, in this embodiment, the following interrelating mechanism interrelated with opening and closing of the openable cover 203 is employed. That is, not only the entrance guide 201 is retracted from the space, permitting demounting of the pressing unit, in interrelation with movement of the openable cover 203 from the closed position to the open position but also the entrance guide 201 is restored to the guiding position in interrelation with movement of the openable cover 203 from the open position to the closed position. As a result, the operator is not required to independently move the openable cover 203 and the entrance guide 201 in order to demount the pressing unit 200, and therefore, an operation during demounting of the pressing unit 200 is facilitated.

FIG. 3 is a sectional view showing a state when the pressing roller 106 in this embodiment is demounted in a state that the fixing film 101a is removed in advance. In order to access the pressing roller 106, there is a need to demount the openable cover 203 thermally insulating the fixing device 40. The openable cover 203 includes a rotation shaft 203a as a first supporting point and is rotatable in a direction of an arrow 203b.

Next, motion of the entrance guide 201 will be described. The entrance guide 201 includes a rotation shaft 201a as a second supporting point and is rotatable in a direction of an arrow 201b. Here, the entrance guide 201 includes a projected portion 201c as a contact portion (a part of the above-described interrelating mechanism interrelated with the opening and closing of the openable cover 203) contacting the openable cover 203. The projected portion 201c is designed to contact the openable cover 203 at a point Y when the openable cover 203 is rotated.

For this reason, in interrelation with the motion such that the openable cover 203 rotates about the rotation shaft 203a as the supporting point in the arrow 203b direction, the entrance guide 201 rotates about the rotation shaft 201a as the supporting point in the arrow 201b direction (i.e., is retracted from an original first position to a second position). In a projection region as viewed from the demounting direction of the pressing roller 106, a downstream region of the entrance guide 201 with respect to a recording material feeding direction overlaps with the pressing roller 106 at the first position, but does not overlap with the pressing roller 106 at the second position.

Thus, the entrance guide 201 is rotated (retracted) by the motion such that the openable cover 203 required to be always opened and closed in order to access the pressing roller 106. As described later, the entrance guide 201 is urged toward the guiding position by a guide urging member 204. However, in a state in which the openable cover 203 is in the closed position, a constitution in which by a weight of the openable cover 203, the entrance guide 201 is maintained in the retracted position against an urging force of the guide urging member 204. As a result, on the broken line Z1 which is the locus drawn when the pressing roller 106 is exchanged, it is possible to avoid inference between the entrance guide 201 and the pressing roller 106.

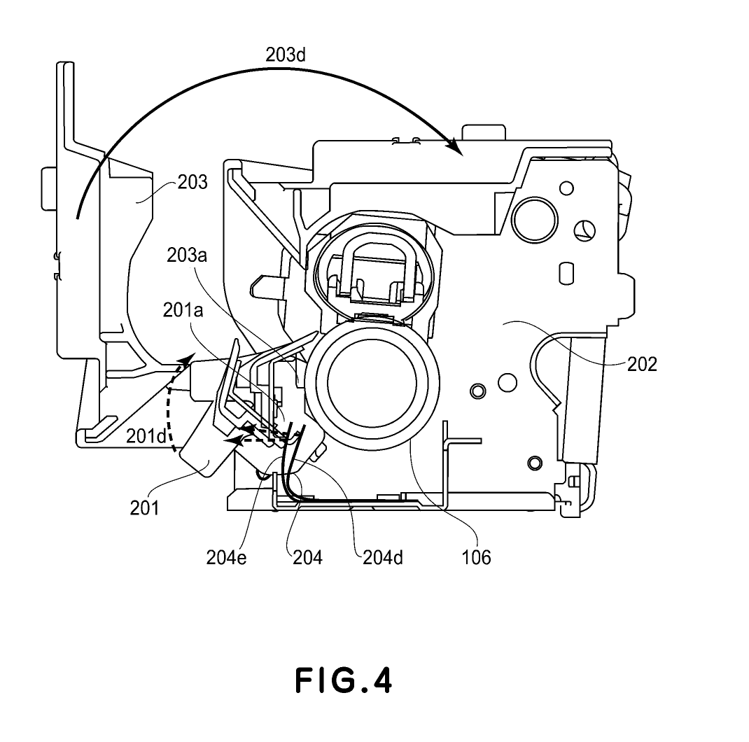

FIG. 4 is a sectional view showing an operation of closing the openable cover 203 in a state in which the pressing roller 106 is exchanged and then the heating unit is disposed. The entrance guide 201 always receives a force from the guide urging member (restoring member, spring member) 204 as a part of the above-described interrelating mechanism interrelated with the opening and closing of the openable cover 203. The guide urging member 204 is a component part for exerting the force on the entrance guide 201 in order to determine an attitude of the entrance guide 201, and the attitude of the entrance guide 201 on which the force is exerted is determined as an abutting attitude against unshown positioning portions provided on the side plates 202. Such a guide urging member 204 is constituted by a thin plate of SUS in this embodiment.

When the openable cover 203 is closed, at the above-described point Y, a contacting force of the openable cover 203 to the projected portion 201c of the entrance guide 201 is eliminated. For this reason, the guide urging member 204 deforms from a state 204d to a state 204e, so that the entrance guide 201 on which the force is exerted in automatically returned (restored) to a normal position (first position) and thus the attitude thereof is fixed.

In this embodiment, as described above, a constitution in which depending on a change in position, from the closed position to the open position, of the openable cover 203 always opened before the pressing roller 106 is demounted, the entrance guide 201 is moved from the normal position (first position) to the retracted position (second position) is employed. Further, a constitution in which when the openable cover 203 is returned to a normal position (closed position), the force is exerted on the entrance guide 201 in the rotational direction by the guide urging member 204 so that the entrance guide 201 is automatically returned to the normal position (first position).

As a result, without providing the photo-sensor as disclosed in JP-A 2011-22536, it becomes possible to achieve prevention of the forgetfulness to close the entrance guide inexpensively and easily. In this embodiment, the reason why the constitution using the interrelating mechanism, not a constitution in which the entrance guide 201 is fixed to the openable cover 203 by fastening with screws or the like, is employed is as follows. That is because the entrance guide 201 can also be moved alone without being restricted to interrelation with the opening and closing operation of the openable cover 203. That is, even in the case where the openable cover 203 is not moved, the entrance guide 201 is movable between the guiding position and the retracted position. For example, in a state in which the openable cover 203 is kept closed, the operator can move the entrance guide 201 against the urging force of the guide urging member 204. As a result, for example, in the case where jammed paper which is not readily removed exists in the fixing device, the operator can move only the entrance guide 201 in order to remove the jammed paper.

In the above-described embodiment, a preferred embodiment of the present invention was described, but the present invention is not limited thereto but can also be variously modified or changed within the scope of thereof. Further, constitutions and arrangements in the above-described embodiment may also be appropriately selected and combined with each other. Further, dimensions, materials, shapes and relative arrangement of constituent parts described in the above-described embodiment should be appropriately changed depending on structures and various conditions of the devices (apparatuses) to which the present invention is applied.

### Modified Embodiment 2

In the above-described embodiment, as the rotatable member in the first fixing unit, the endless belt was used, but a fixing roller may also be used. Further, as the opposing member in the second fixing unit, the pressing roller was used, but the endless belt was used. Further, the endless belt may also be used as both the rotatable member and the opposing member.

Further, in the above-described embodiment, the case where the endless belt as the rotatable member is pressed by the pressing roller as the opposing member was described. However, the present invention is not limited thereto, but is similarly applicable to also the case where the an opposing member is pressed by the endless belt as the rotatable fixing member.

### Modified Embodiment 2

In the above-described embodiment, the fixing device for fixing the unfixed toner image on the sheet was described, but the present invention is not limited thereto, but may also be applicable to a device for heat-pressing a toner image, temporarily fixed on a sheet, in order to improve glossiness of an image.

### Modified Embodiment 3

In the above-described embodiment, as the recording material, the recording paper was described, but the recording material in the present invention is not limited to the paper. In general, the recording material is a sheet-shaped member on which the toner image is formed by the image forming apparatus and includes, for example, regular or irregular members of plain paper, thick paper, thin paper, envelope, post-card, seal, resin sheet, OHP sheet, glossy paper and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2017-038182 filed on Mar. 1, 2017 and 2017-252970 filed on Dec. 28, 2017, which are hereby incorporated by reference herein in their entirety.

What is claimed is:

1. A fixing device comprising:
a first unit including a first rotatable member;
a second unit including a second rotatable member forming a nip, in cooperation with said first rotatable member, for fixing a toner image on a recording material;
a frame supporting said second unit;
a guiding member movable between a guiding position for guiding the recording material toward the nip and a retracted position where said guiding member is retracted from a space permitting demounting of said second unit from said frame;
a cover member openable for exposing the space; and
an interrelating mechanism configured to restore said guiding member, which is in the retracted position when said cover member is in an open position, to the guiding position in interrelation with movement of said cover member from the open position to a closed position.

2. A fixing device according to claim 1, wherein said interrelating mechanism moves said guiding member to the retracted position in interrelation with movement of said cover member from the closed position to the open position.

3. A fixing device according to claim 1, wherein a demounting direction of said second unit from said frame is a direction in which said second unit approaches a position where said first unit has already been demounted.

4. A fixing device according to claim 1, wherein the space is exposed by demounting said first unit.

5. A fixing device according to claim 1, wherein in a projection plane when said guiding member being in the guiding position is viewed in a demounting direction of said second unit, a part of said guiding member and a part of said second rotatable member overlap with each other.

6. A fixing device according to claim 1, wherein said guiding member is movable between the guiding position and the retracted position without movement of said cover member.

7. A fixing device according to claim 1, wherein said interrelating mechanism includes a spring member configured to urge said cover member from the open position toward the closed position.

8. A fixing device according to claim 2, wherein said interrelating mechanism includes a contact portion contacting said cover member with the movement of said cover member from the closed position to the open position, said contact portion being provided on said guiding member.

9. A fixing device according to claim 1, wherein said frame detachably supports said first unit.

10. A fixing device according to claim 1, wherein said cover member is rotatable about a first supporting point between the closed position and the open position, and said interrelating mechanism retracts said guiding member depending on a change in position of said cover member from the closed position to the open position.

11. A fixing device according to claim 1, wherein said guiding member is rotatable about a second supporting point different from the first supporting point and is retracted by being rotated about the second supporting point by the interrelating mechanism.

12. A fixing device according to claim 1, wherein said first rotatable member contacts an unfixed toner image in the nip.

13. An image forming apparatus comprising:
an image forming portion configured to form a toner image;
a first unit including a first rotatable member;
a second unit including a second rotatable member forming a nip for feeding a recording material in cooperation with said first rotatable member;
a frame supporting said second unit;
a guiding member movable between a guiding position for guiding the recording material toward the nip and a retracted position where said guiding member is retracted from a space permitting demounting of said second unit from the frame;
a cover member openable for exposing the space; and
an interrelating mechanism configured to restore said guiding member, which is in the retracted position when said cover member is in an open position, to the guiding position in interrelation with movement of said cover member from the open position to a closed position.

14. An image forming apparatus according to claim 13, further comprising a second cover member openable for exposing a space permitting demounting, from a main assembly of said image forming apparatus, of a unit including said second unit, said frame, said guiding member, said cover member and said interrelating mechanism.

15. An image forming apparatus according to claim 13, further comprising a second cover member openable for exposing a space permitting demounting of said image forming portion from a main assembly of said image forming apparatus,
wherein said first rotatable member and said second rotatable member fixes the toner image on the recording material in the nip.

16. An image forming apparatus according to claim 13, wherein said interrelating mechanism moves said guiding member to the retracted position in interrelation with movement of said cover member from the closed position to the open position.

17. An image forming apparatus according to claim 13, wherein a demounting direction of said second unit from said frame is a direction in which said second unit approaches a position where said first unit has already been demounted.

18. An image forming apparatus according to claim 13, wherein the space is exposed by demounting said first unit.

19. An image forming apparatus according to claim 13, wherein in a projection plane when said guiding member being in the guiding position is viewed in a demounting direction of said second unit, a part of said guiding member and a part of said second rotatable member overlap with each other.

20. An image forming apparatus according to claim 13, wherein said frame detachably supports said first unit.
